(19) United States
(12) Patent Application Publication
(10) Pub. No.: US 2021/0070624 A1
(43) Pub. Date: Mar. 11, 2021

(54) METHOD FOR CONTROLLING THE CONCENTRATION OF IMPURITIES IN BAYER LIQUORS

(71) Applicant: ALCOA OF AUSTRALIA LIMITED, Booragoon (AU)

(72) Inventors: Shannon Dye, Booragoon (AU); Bronwyn Larner, Booragoon (AU); Anthony John McKinnon, Booragoon (AU)

(21) Appl. No.: 17/101,496

(22) Filed: Nov. 23, 2020

Related U.S. Application Data
(63) Continuation of application No. PCT/US2019/050477, filed on May 17, 2019.

(30) Foreign Application Priority Data
May 28, 2018 (AU) 2018901884

(51) Int. Cl. C01F 7/47; C01F 7/16; C22B 21/00; C22B 3/44

(52) U.S. Cl. CPC C01F 7/47; C01F 7/162; C22B 3/44; C22B 21/0015; C01F 7/164

(57) ABSTRACT

A method for controlling the concentration of impurities in Bayer liquors, the method comprising the steps of adding an oxide and/or a hydroxide of a metal other than aluminium to a Bayer liquor with a desired TA; forming a layered double hydroxide; and incorporating at least one impurity in said layered double hydroxide, wherein the impurities are selected from the group comprising phosphorus, vanadium and silicon.

### CROSS-REFERENCE TO RELATED APPLICATIONS

This application is a continuation of International Patent Application No. PCT/AU2019/050477, filed May 17, 2019, which claims priority to Australian Patent Application No. 2018901884, filed May 28, 2018, entitled “Method for Controlling the Concentration of Impurities in Bayer Liquors”, each of which is incorporated herein by reference in its entirety.

### TECHNICAL FIELD

A method for controlling the concentration of impurities in Bayer liquors.

The Bayer process is widely used for the production of alumina from alumina containing ores, such as bauxite. The process involves contacting alumina containing ores with recycled caustic aluminate solutions, at elevated temperatures, in a process commonly referred to as digestion. Solids are removed from the resulting slurry, and the solution cooled.

Aluminium hydroxide is added to the solution as seed to induce the precipitation of further aluminium hydroxide therefrom. The precipitated aluminium hydroxide is separated from the caustic aluminate solution, with a portion of the aluminium hydroxide being recycled to be used as seed and the remainder recovered as product. The remaining caustic aluminate solution is recycled for further digestion of alumina containing ore.

Bauxite ore generally contains inorganic impurities, the amounts of which are specific to the bauxite source. As aluminium hydroxide is precipitated and bauxite dissolved, the concentrations of sodium hydroxide present in the process solution decrease, whilst concentrations of impurities increases, reducing the efficacy of the solution for digestion of further aluminium-containing ore. Accordingly, processes aimed at removing impurities from Bayer liquors have been developed.

Alumina refineries have developed numerous methods to address impurities in liquors and reduce their build up. Most impurity removal techniques are specific to the impurity in question, thereby complicating the entire circuit. For example, silicon may be removed via precipitation of desilication product, phosphorus by the addition of lime to form hydroxyapatite and vanadium by the formation of fluovanadate salts.

Layered Double Hydroxides (LDHs) are a family of lamellar minerals composed of positively charged layers charge balanced with hydrated weakly bound anions located in the interlayer spaces. Most LDHs are binary systems where the charge on the layers is due to the substitution of some of the divalent cation sites within the lattice by mono- and/or tri-valent cations, giving a general formula of:

[M^{II}₁₋ₓM^{III}ₓ(OH)₂]^{q+}(Aⁿ⁻)_{x/n}.yH₂O or

[M^{I}M^{III}₂(OH)₆](Aⁿ⁻)_{1/n}.yH₂O

where M^{I}, M^{II} and M^{III} represents the mono-, di- and tri-valent metal cations within the layers respectively and A represents the interlayer anion(s).

In the above formula, ‘A’ may be mono-, di- or multi-valent as long as the overall charge of the structure is neutral.

The most common naturally occurring LDHs are members of the Hydrotalcite (HTC) group, characterised by M²⁺:M³⁺=3:1. The name-sake of this group, hydrotalcite, is a Mg—Al structure and has the general formula of [Mg₃Al(OH)₆]₂.X.nH₂O, where ‘X’ represents the charge balancing anion(s).

Another group of LDHs referred to in this specification is the Hydrocalumite (HCM) group, which is characterised by M²⁺:M³⁺=Ca²⁺:Al³⁺=2:1. Hydrocalumite has the general formula of [Ca₂Al(OH)₆]ₓ.X.nH₂O, where ‘X’ is more specifically, one formula unit of a singly charged anion or half of a doubly charged anion. It will be appreciated that this is a general formula only and that X may be a combination of anions.

Throughout the specification, unless the context requires otherwise, the word “comprise” or variations such as “comprises” or “comprising”, will be understood to imply the inclusion of a stated integer or group of integers but not the exclusion of any other integer or group of integers.

Throughout the specification, unless the context requires otherwise, the word “solution” or variations such as “solutions”, will be understood to encompass slurries, suspensions and other mixtures containing undissolved solids.

The preceding discussion of the background to the invention is intended to facilitate an understanding of the present invention. However, it should be appreciated that the discussion is not an acknowledgement or admission that any of the material referred to was part of the common general knowledge in Australia or any other country as at the priority date.

### SUMMARY OF INVENTION

In accordance with the present invention, there is provided a method for controlling the concentration of impurities in Bayer liquors, the method comprising the steps of:
adding an oxide and/or a hydroxide of a metal other than aluminium to a Bayer liquor with a desired TA;
forming a layered double hydroxide; and
incorporating at least one impurity in said layered double hydroxide,
   wherein the impurities are selected from the group comprising phosphorus, vanadium and silicon and the incorporation of the at least one impurity decreases with increasing TA.

In accordance with the present invention, there is provided a method for controlling the concentration of impurities in Bayer liquors, the method comprising the steps of:
obtaining a liquor with a desired TA;
adding an oxide and/or a hydroxide of a metal other than aluminium to the Bayer liquor;
forming a layered double hydroxide; and
incorporating at least one impurity in said layered double hydroxide,
wherein the impurities are selected from the group phosphorus, vanadium and silicon and wherein obtaining a liquor with a lower TA provides increased incorporation of sulfate and/or TOC than obtaining a liquor with a higher TA.

An important property of a Bayer liquor is its alkalinity, the total amount of alkali chemicals in the liquor. Most of the liquor alkalinity comes from the sodium hydroxide present, the other major contributor being sodium carbonate. The total alkalinity of a Bayer liquor is commonly described in terms of its TA which is measured in gL⁻¹ expressed as Na₂CO₃.

In the context of the present invention, the term incorporation shall be understood to include intercalation of impurities and adsorption of impurities.

It will be appreciated that the impurities may exist in many forms in a Bayer liquor, including as oxyanions.

Preferably, the desired TA is less than 160 gL⁻¹.

In one form of the invention, the method comprises the further step of monitoring the concentration of at least one impurity in a Bayer circuit. Monitoring the concentration of at least one impurity in a Bayer circuit may comprise measuring the concentration of at least one impurity at any location within the Bayer circuit.

In one form of the invention, the method comprises the further step of measuring the concentration of at least one impurity in the Bayer liquor with a desired TA.

In one form of the invention, the method comprises the further step of:
measuring the concentration of at least one impurity in a Bayer liquor with a desired TA;
   prior to the step of:
adding an oxide and/or a hydroxide of a metal other than aluminium to a Bayer liquor with a desired TA.

In one form of the invention, the method comprises the further step of:
measuring the concentration of at least one impurity in a Bayer liquor with a desired TA;
   after the step of:
incorporating at least one impurity in said layered double hydroxide.

In one form of the invention, the method comprises the further step of:
measuring the concentration of at least one impurity in a Bayer liquor with a desired TA;
   both prior to and after the step of:
incorporating at least one impurity in said layered double hydroxide.

Advantageously, the concentration of at least one impurity in the Bayer liquor after the formation of the layered double hydroxide is less than the concentration of at least one impurity prior to the step of adding an oxide and/or a hydroxide of a metal other than aluminium to a Bayer liquor.

In one form of the invention, the method comprises the step of:

obtaining a Bayer liquor with a desired TA.

In one form of the invention, the method comprises the step of:

treating the Bayer liquor to provide a Bayer liquor with a desired TA.

The Bayer liquor may be treated prior to the step of adding an oxide and/or a hydroxide of a metal other than aluminium to the Bayer liquor, to reduce the TA of the Bayer liquor. Treatment of the Bayer liquor to reduce the TA may include dilution the Bayer liquor with water or a second Bayer liquor.

In one form of the invention, the method comprises the further step of:
diluting the Bayer liquor
   prior to or concurrently with the step of:
adding an oxide and/or a hydroxide of a metal other than aluminium to a Bayer liquor with a desired TA;

Advantageously, the degree of incorporation of at least one impurity increases with liquor dilution.

In one form of the invention, the TA is set to a predetermined value to maximise the incorporation of at least one target impurity.

In one form of the invention, the step of incorporating at least one impurity in said layered double hydroxide results in a reduction of the concentration of the at least one impurity of at least 10%. In one form of the invention, the step of incorporating at least one impurity in said layered double hydroxide results in a reduction of the concentration of the at least one impurity of at least 20%. In one form of the invention, the step of incorporating at least one impurity in said layered double hydroxide results in a reduction of the concentration of the at least one impurity of at least 30%. In one form of the invention, the step of incorporating at least one impurity in said layered double hydroxide results in a reduction of the concentration of the at least one impurity of at least 40%. In one form of the invention, the step of incorporating at least one impurity in said layered double hydroxide results in a reduction of the concentration of the at least one impurity of at least 50%. In one form of the invention, the step of incorporating at least one impurity in said layered double hydroxide results in a reduction of the concentration of the at least one impurity of at least 60%. In one form of the invention, the step of incorporating at least one impurity in said layered double hydroxide results in a reduction of the concentration of the at least one impurity of at least 70%. In one form of the invention, the step of incorporating at least one impurity in said layered double hydroxide results in a reduction of the concentration of the at least one impurity of at least 80%. In one form of the invention, the step of incorporating at least one impurity in said layered double hydroxide results in a reduction of the concentration of the at least one impurity of at least 90%.

The inventors have identified that when the TA of the Bayer liquor is below 160 gL⁻¹, it is possible to incorporate phosphorus, silicon and vanadium into layered double hydroxides thereby removing them from the Bayer liquor. The degree of incorporation increases as the TA is reduced. The present invention makes it possible to target and remove these impurities in Bayer liquors. Under certain conditions, it is possible to remove these impurities in preference to other impurities.

In one form of the invention, the method comprises the further step of:
adding at least one impurity to the Bayer liquor to provide an enriched Bayer liquor;

prior to the step of:
forming a layered double hydroxide

Preferably, the step of:
adding at least one impurity to the Bayer liquor to provide an enriched Bayer liquor;
   is conducted prior to the step of:
adding an oxide and/or a hydroxide of a metal other than aluminium to the Bayer liquor with a desired TA;

Preferably, the at least one impurity added to the Bayer liquor is the same as the at least one impurity incorporated into the layered double hydroxide.

In one form of the invention, the method comprises the further step of:
separating the layered double hydroxide from the Bayer liquor to provide an impurity depleted liquor.

Preferably, the impurity depleted liquor is returned to the Bayer circuit.

In preferred forms of the invention, the formation of a layered double hydroxide under the conditions of the desired TA facilitates the incorporation of at least one impurity over at least one other impurity.

In the context of the present specification, the term facilitate shall not be limited to the incorporation of one impurity to the exclusion of others.

In preferred forms of the invention, the desired TA favours the incorporation of at least one impurity over at least one other impurity.

In the context of the present specification, the term favour shall not be limited to the incorporation of one impurity to the exclusion of others.

It will be appreciated that the step of incorporating at least one impurity in said layered double hydroxide will not necessarily mean that all of said impurity in the Bayer liquor is incorporated into said layered double hydroxide.

Preferably, the Bayer liquor is a washer overflow, diluted spent liquor, diluted green liquor or lakewater.

It will be appreciated that the oxide and/or a hydroxide of a metal other than aluminium will need to be one that can form a layered double hydroxide. In preferred forms of the invention, the metal other than aluminium is selected from the group comprising calcium and magnesium.

Preferably, the layered double hydroxide is hydrocalumite and/or hydrotalcite.

Preferably, the metal oxide other than aluminium is calcium hydroxide. Preferably, the calcium hydroxide is prepared by slaking calcium oxide. Preferably, the calcium oxide is slaked in lakewater. It will be appreciated that the addition of slaked lime to the Bayer liquor will decrease the TA of said liquor.

It will be appreciated that the lime charge will be dependent on the liquor type and concentration. While it is desirable to maximise the conversion to hydrocalumite, care should be taken not to deplete the liquor of alumina or carbonate.

In one form of the invention, the Bayer liquor has a TA less than 100 gL⁻¹. In an alternate form of the invention, the Bayer liquor has a TA less than 75 gL⁻¹.

In an alternate form of the invention, the Bayer liquor has a TA between 50 and 100 gL⁻¹.

It will be appreciated that the desired TA will be influenced by the choice of liquor. Where the liquor is a washer overflow, diluted spent liquor or diluted green liquor, the TA is preferably between 50 and 75 gL⁻¹. Where the liquor is a lakewater, the TA is preferably less than 50 gL⁻¹.

Given that the incorporation of phosphorous, silicon and vanadium ions are favoured by lower TA's, it is possible using the method of the present invention to target these impurities over others in Bayer liquors.

Advantageously, the present invention allows a user to choose a TA that provides the best absolute or relative removal of at least one impurity over at least one other impurity.

Advantageously, the method of the present invention provides the vehicle to remove target impurities in Bayer liquors. To date, this has not been achievable as the relationship of impurity incorporation in layered double hydroxides with TA was not known. By controlling the TA of the Bayer liquor it is now possible to change the selectivities of layered double hydroxides for some impurities.

The method of the present invention may be used to prepare impurity-substituted layered double hydroxides.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a plot showing the effect of TA on P₂O₅ and SiO₂ incorporation into hydrocalumite for the series of runs with 1^{st} refinery spent liquor shown in Table 1:

FIG. 2 is a plot showing the effect of TA on P₂O₅ and SiO₂ incorporation into hydrocalumite for the series of runs with 2^{nd} refinery spent liquor shown in Table 2;

FIG. 3 is a plot showing the effect of TA on P₂O₅ SiO₂ and V₂O₅ incorporation into hydrocalumite for the series of runs with 3^{rd} refinery spent liquor shown in Table 3;

FIG. 4 is a plot showing the effect of TA on P₂O₅ and SiO₂ incorporation into hydrocalumite for the series of runs with 1^{st} refinery green liquor shown in Table 4;

FIG. 5 is a plot showing the effect of TA on P₂O₅ incorporation into hydrocalumite for liquors spiked with P₂O₅;

### DESCRIPTION OF EMBODIMENTS

Throughout this specification, unless the context requires otherwise, the word “comprise” or variations such as “comprises” or “comprising”, will be understood to imply the inclusion of a stated integer or group of integers but not the exclusion of any other integer or group of integers.

Those skilled in the art will appreciate that the invention described herein is amenable to variations and modifications other than those specifically described. It is to be understood that the invention includes all such variations and modifications. The invention also includes all of the steps, features, compositions and compounds referred to or indicated in the specification, individually or collectively and any and all combinations or any two or more steps or features.

### Experimental

To further describe the invention, a series of experiments will now be described. It must be appreciated that the following description of the experiments is not to limit the generality of the above description of the invention.

Experiments were conducted in 3 L stainless steel water jacketed vessels with constant stirring at 1000 RPM. The temperature was maintained at 60° C. and the vessels contained baffles to ensure good mixing. The duration of each experiment was one hour.

Liquors from three alumina refineries (hereinafter the 1^{st} Refinery, the 2^{nd} Refinery and the 3^{rd} Refinery) were used and slaked lime was sourced from the 2^{nd} Refinery. The slaked lime typically had a solids concentration of 250 gL⁻¹ with an available CaO content of approximately 56%. This lime had been produced by slaking in 2^{nd} Refinery lakewater.

The ratios of lime to liquor were kept constant and the TA was varied by changing the amount of distilled water added to the reaction mixture. The total reaction volume was approximately 2 L.

The concentration of impurity in the original spent liquor and the exit liquor was determined by ICP-OES. The amount of the impurities removed was calculated from a mass balance of the total impurities in the feed streams (liquor and lake water from slaked lime) compared to the total impurities present in the exit liquor. The difference between the feed and exit was assumed to be due to incorporation into the hydrocalumite. Due to a significant volume change during the reaction, an internal standard had to be used to determine volume of the exit liquor. Sodium malonate was used as the internal standard as it is not incorporated into the hydrocalumite.

The effect of TA on the uptake of P₂O₅, SiO₂ and V₂O₅ was investigated with spent liquors from all three refineries and green liquor from the 1^{st} refinery.

The concentration of lime added to the reaction mixture was 100 g CaOL⁻¹ of spent liquor for the 1^{st} refinery (both spent and green liquors) and the 2^{nd} refinery experiments, and 125 g CaOL⁻¹ of spent liquor from the 3^{rd} refinery. The total liquid volume was approximately 2 L (liquor plus distilled water plus lime slurry lake water [88% of lime slurry volume]).

This sample of 1^{st} refinery spent liquor had a TA of 262 gL⁻¹ (as Na₂CO₃). This liquor was diluted according to Table 1, to produce a series of liquors with decreasing TA. The actual TA of the reaction mixtures (reaction TA) was less than the water dilution alone due to the extra dilution caused by the lake water contained in the lime slurry. The lime slurry added was proportional to the original feed spent liquor added, which is why the lime slurry volume and lime concentration in the reactor decreases through the experimental runs. The CaO added was relatively constant when proportioned to the feed liquor (approximately 104 gL⁻¹).

TABLE 1
Effect of TA reaction mixtures for the 1^{st} refinery experiments

| | | | | | CaO | |
|---|---|---|---|---|---|---|
| | | | Lime | Lime | conc in | |
| | Liquor | Water | Slurry | conc in | feed | |
| Run | volume | volume | volume | reactor | liquor | Reaction |
| number | (L) | (L) | (L) | (gL⁻¹) | (gL⁻¹) | TA (gL⁻¹) |
| 1 | 1.30 | 0.00 | 0.97 | 110.1 | 106 | 165.9 |
| 2 | 1.15 | 0.24 | 0.86 | 98.4 | 106 | 147.4 |
| 3 | 1.00 | 0.48 | 0.74 | 85.9 | 105 | 129.1 |
| 4 | 0.85 | 0.73 | 0.63 | 73.4 | 105 | 109.6 |
| 5 | 0.70 | 0.98 | 0.52 | 60.3 | 104 | 90.4 |
| 6 | 0.55 | 1.24 | 0.40 | 47.0 | 103 | 70.7 |
| 7 | 0.40 | 1.52 | 0.29 | 33.3 | 101 | 50.7 |
| 8 | 0.23 | 1.72 | 0.17 | 20.3 | 103 | 30.2 |

FIG. 1 shows the amount of phosphorus and silica removed per tonne of hydrocalumite produced for the 1^{st} refinery spent liquor. As the reaction TAs decrease the uptake by hydrocalumite for both P₂O₅ and SiO₂ increases. For both the P₂O₅ and SiO₂, it is assumed that none of these impurities in the lime solids dissolve under these mild reaction conditions so they are excluded from the input mass balance (XRF analysis show typically 0.94% for SiO₂ and 0.11% for P₂O₅ in the lime solids). At the undiluted TA, with no additional water added (run 1), there was 0 gT⁻¹ uptake for P₂O₅ and there was an increase in SiO₂ into the malonate normalised product liquor (producing the negative uptake), indicating that some of the SiO₂ from the solid lime phase was dissolving to some extent. This means that there may be a higher impurity uptake if there is dissolution of the impurities from the solid phase of the lime, but as this uptake is difficult to quantify, it has been excluded from the mass balance.

The concentration of P₂O₅ and SiO₂ in the feed liquor was 168 mgL⁻¹ and 715 mgL⁻¹. The percentage removed at the lowest TA was 75% for P₂O₅ and 67% for SiO₂. In the lowest TA run, there were small amounts of P₂O₅ and SiO₂ left in the product liquor at the end of the experiment (4.6 mgL⁻¹ P₂O₅ and 25.7 mgL⁻¹ SiO₂ remaining).

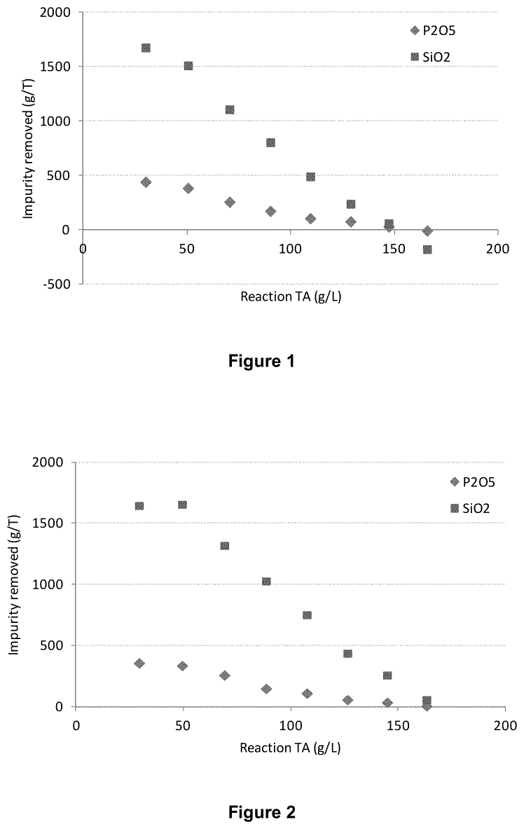

The uptake of SiO₂ and P₂O₅ was also tested in 2^{nd} refinery spent liquor (see Table 2 for liquor conditions), showing a similar increase in uptake with decreasing TA (FIG. 2). The initial TA of the liquor was 256 gL⁻¹. Uptake did not appear to change significantly between the two lowest reactions TAs for these experiments.

TABLE 2
Effect of TA reaction mixtures for the 2^{nd} refinery experiments

| | | | | | CaO | |
|---|---|---|---|---|---|---|
| | | | Lime | Lime | conc in | |
| | Liquor | Water | Slurry | conc in | feed | |
| Run | volume | volume | volume | reactor | liquor | Reaction |
| number | (L) | (L) | (L) | (gL⁻¹) | (gL⁻¹) | TA (gL⁻¹) |
| 1 | 1.30 | 0.00 | 0.96 | 108.9 | 104 | 163.5 |
| 2 | 1.15 | 0.24 | 0.85 | 97.2 | 104 | 145.2 |
| 3 | 1.00 | 0.48 | 0.74 | 85.3 | 104 | 126.7 |
| 4 | 0.85 | 0.73 | 0.62 | 72.4 | 103 | 107.8 |
| 5 | 0.70 | 0.98 | 0.51 | 59.4 | 102 | 88.7 |
| 6 | 0.55 | 1.24 | 0.39 | 46.3 | 101 | 69.3 |
| 7 | 0.40 | 1.52 | 0.28 | 33.0 | 100 | 49.6 |
| 8 | 0.23 | 1.72 | 0.17 | 20.2 | 102 | 29.6 |

In this liquor, the concentration of P₂O₅ was 149 mgL⁻¹ and the concentration of SiO₂ was 765 mgL⁻¹ with 70% and 63% of the impurities removed at the lowest TA run. SiO₂ uptake was higher in the 2^{nd} refinery liquor than the 1^{st} refinery liquor which agrees with the concentration of SiO₂ in the starting liquors with the 2^{nd} refinery liquor having a higher SiO₂ concentration (765 mgL⁻¹ vs 715 mgL⁻¹). Uptakes were similar for P₂O₅ where 1^{st} refinery had a slightly higher P₂O₅ concentration compared to the 2^{nd} refinery, 168 mgL⁻¹ vs 149 mgL⁻¹.

The experiments were repeated with the 3^{rd} refinery spent liquor; this time at a higher CaO charge. Experimental liquor conditions are shown in Table 3. The initial TA of this liquor was 272 gL⁻¹. These results also include V₂O₅ as a part of the ICP-OES analysis suite.

TABLE 3
Effect of TA reaction mixtures for the 3^{rd} refinery experiments

| | | | | | CaO | |
|---|---|---|---|---|---|---|
| | | | Lime | Lime | conc in | |
| | Liquor | Water | Slurry | conc in | feed | |
| Run | volume | volume | volume | reactor | liquor | Reaction |
| number | (L) | (L) | (L) | (gL⁻¹) | (gL⁻¹) | TA (gL⁻¹) |
| 1 | 1.30 | 0.00 | 1.01 | 128.1 | 125.2 | 171.1 |
| 2 | 1.15 | 0.24 | 0.89 | 114.4 | 124.7 | 152.3 |
| 3 | 1.00 | 0.48 | 0.78 | 101.1 | 125.7 | 132.8 |
| 4 | 0.85 | 0.73 | 0.66 | 86.3 | 125.1 | 113.1 |
| 5 | 0.70 | 0.98 | 0.54 | 71.3 | 124.3 | 93.3 |
| 6 | 0.55 | 1.24 | 0.43 | 56.8 | 126.0 | 72.8 |
| 7 | 0.40 | 1.52 | 0.31 | 40.7 | 124.9 | 52.3 |
| 8 | 0.23 | 1.72 | 0.18 | 24.8 | 126.1 | 31.3 |

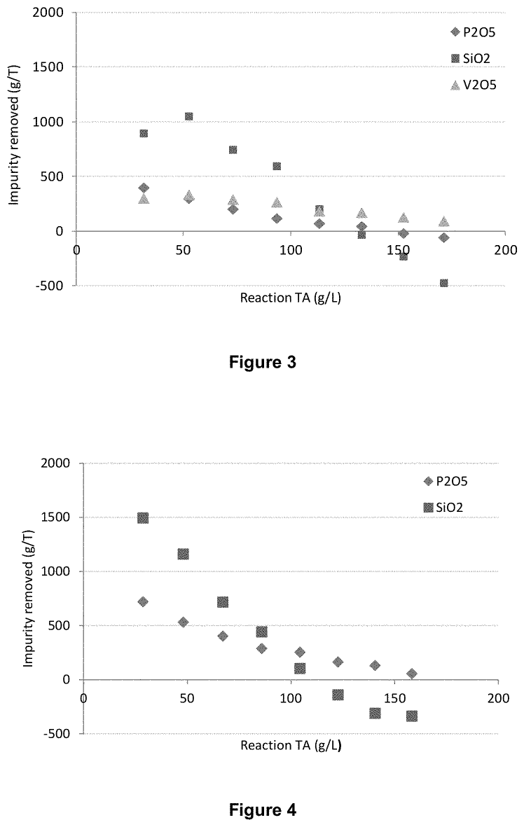

For all three impurities, the uptake into the hydrocalumite increased with decreasing TA (FIG. 3). Compared to the 1^{st} and 2^{nd} refinery liquors, SiO₂ uptake turned positive at a lower TA (approximately 130 gL⁻¹, compared to 150 gL⁻¹ for the 1^{st} refinery liquor and all tests for the 2^{nd} refinery liquor). This was due to the dissolution of some SiO₂ in the lime and the higher lime charge in the 2rd refinery liquor experiments meant a lower TA had to be achieved before the net uptake exceeded the dissolution. Due to this, although the higher lime charge gave a higher yield per litre of liquor, at a given TA the uptake was less for the 3^{rd} refinery than the other two. The slopes of the SiO₂ points in FIGS. 1-3 were similar, indicating the change in uptake with TA did not vary with the three liquors.

The uptake of SiO₂ and P₂O₅ was also tested in 1^{st} refinery green liquor (see Table 4 for liquor conditions), showing a similar increase in uptake with decreasing TA (FIG. 4). The initial TA of this liquor was 247.5 gL⁻¹, which was lower than the spent liquors from the three refineries.

TABLE 4
Effect of TA reaction mixtures for the 1^{st} refinery experiments

| | | | | | CaO | |
|---|---|---|---|---|---|---|
| | | | Lime | Lime | Conc in | |
| | Liquor | Water | Slurry | Conc in | feed | |
| Run | volume | volume | volume | Reactor | liquor | Reaction |
| number | (L) | (L) | (L) | (gL⁻¹) | (gL⁻¹) | TA (gL⁻¹) |
| 1 | 1.30 | 0.00 | 0.96 | 108.9 | 104.0 | 158.3 |
| 2 | 1.15 | 0.24 | 0.85 | 97.2 | 104.0 | 140.5 |
| 3 | 1.00 | 0.48 | 0.74 | 85.3 | 104.0 | 122.6 |
| 4 | 0.85 | 0.73 | 0.62 | 72.4 | 103.0 | 104.3 |
| 5 | 0.70 | 0.98 | 0.51 | 59.4 | 102.0 | 85.9 |
| 6 | 0.55 | 1.24 | 0.39 | 46.3 | 101.0 | 67.1 |
| 7 | 0.40 | 1.52 | 0.28 | 33.0 | 100.0 | 48.0 |
| 8 | 0.23 | 1.72 | 0.17 | 20.2 | 102.0 | 28.6 |

Phosphorus uptake increased as TA decreased like the spent liquors, but uptake in the green liquor was significantly higher for P₂O₅. SiO₂ uptake also show the trend of increasing uptake with decreasing TA, although SiO₂ uptake was lower in the 1^{st} refinery green liquor than the 1^{st} refinery spent liquor.

The uptake of the three impurities was investigated in 1^{st} refinery and 3rd refinery lakewaters with TA's of 27 gL⁻¹ and 23 gL⁻¹ respectively. Unlike the previous suite of experiments, where water was added to lower the TA, the amount of lime slurry added was adjusted to 20 gL⁻¹ (based on reactor volume) which was similar to the amount of lime added for the spent liquor experiments at the lowest TA. No additional water was added to the reaction solution. Reaction conditions and the uptakes for P₂O₅ and V₂O₅ are shown in Table 5. Due to SiO₂ levels in the lakewater being close to the detection limit of the ICP-OES, results from SiO₂ were excluded from the impurity removal calculation. Comparing the uptake of P₂O₅ in the 1^{st} refinery lake water to the lowest dilution spent liquor, showed a lower uptake in the lakewater than the spent liquor. This difference could be due to the lakewater start and end liquor being at the low end of the analytical range of analysis, where the diluted 45E liquor mass balance was calculated based on an analysis of the neat liquor. Results for P₂O₅ and V₂O₅ were more comparable when comparing diluted 3rd refinery spent liquor and lakewater.

TABLE 5
Liquor conditions and impurity uptake for 1^{st} refinery and 3^{rd}
refinery lake water experiments

| | | | | CaO | | | |
|---|---|---|---|---|---|---|---|
| | | | Lime | Conc in | | | |
| | | Lime | Conc in | feed | Reaction | P₂O₅ | V₂O₅ |
| Run | Liquor | Slurry | Reactor | liquor | TA | uptake | uptake |
| number | vol (L) | vol (L) | (gL⁻¹) | (gL⁻¹) | (gL⁻¹) | (gT⁻¹) | (gT⁻¹) |
| 1^{st} - 1 | 2.02 | 0.15 | 20.2 | 11.7 | 27.2 | 264.3 | 112.6 |
| 1^{st} - 2 | 2.02 | 0.15 | 20.2 | 11.7 | 27.2 | 308.0 | 131.6 |
| 3^{rd} - 1 | 1.50 | 0.11 | 20.0 | 11.5 | 22.7 | 415.4 | 255.8 |
| 3^{rd} - 2 | 1.50 | 0.11 | 20.0 | 11.5 | 22.7 | 453.2 | 406.4 |

To further investigate the uptake of phosphorus, P₂O₅ was spiked into some neat 1^{st} refinery spent liquor and some diluted 1^{st} refinery spent (low TA conditions). Three liquor solutions were prepared: 2 litres of neat liquor, 2 litres of liquor with 50 mgL⁻¹ P₂O₅ added and 2 litres of liquor with 100 mgL⁻¹ P₂O₅ added. The P₂O₅ addition was by the addition of 5 or 10 mL of a 20 mgmL⁻¹ P₂O₅ stock solution (107.13 gL⁻¹ Na₃PO₄.12H₂O). These three liquors with 0, 50 or 100 mgL⁻¹ of additional P₂O₅ were used undiluted or diluted to 25% strength with the addition of water (Table 6).

TABLE 6
P₂O₅ spiking reaction mixtures in 1^{st} refinery spent liquor

| | | | | | CaO | | | |
|---|---|---|---|---|---|---|---|---|
| | | | Lime | Lime | conc in | | | |
| | Liquor | Water | Slurry | conc in | feed | | Additional | |
| Run | volume | volume | volume | reactor | liquor | Reaction | P₂O₅ | |
| number | (L) | (L) | (L) | (gL⁻¹) | (gL⁻¹) | TA (gL⁻¹) | (mgL⁻¹) | Notes |
| 1 | 1.2 | 0 | 1.05 | 136.7 | 141.0 | 155.09 | 0 | Neat |
| | | | | | | | | liquor |
| 2 | 1.2 | 0 | 1.05 | 136.7 | 141.0 | 154.45 | 50 | Neat |
| | | | | | | | | liquor |
| 3 | 1.2 | 0 | 1.05 | 136.7 | 141.0 | 154.45 | 100 | Neat |
| | | | | | | | | liquor |
| 4 | 0.4 | 1.2 | 0.35 | 52.6 | 141.0 | 57.31 | 0 | Low TA |
| 5 | 0.4 | 1.2 | 0.35 | 52.6 | 141.0 | 57.07 | 50 | Low TA |
| 6 | 0.4 | 1.2 | 0.35 | 52.6 | 141.0 | 57.07 | 100 | Low TA |

Table 7 shows the concentration of P₂O₅ in the starting liquor (without the dilution due to the lime and the water [for runs 4-6]), P₂O₅ in the end liquor (both raw and corrected back to neat liquor conditions with a malonate normalisation), the difference in concentration and impurity removal based on the mass balance.

TABLE 7
Liquor results for P₂O₅ spiking experiments.

| | P₂O₅ | P₂O₅ in | P₂O₅ in | | |
|---|---|---|---|---|---|
| | in neat | product | product liquor | Start-End | Impurity |
| Run | liquor | liquor | (normalised)* | difference | removal |
| number | (mgL⁻¹) | (mgL⁻¹) | (mgL⁻¹) | (mgL⁻¹) | (gT⁻¹) |
| 1 | 150.9 | 99.5 | 146.7 | 4.2 | −29 |
| 2 | 201.2 | 122.0 | 180.2 | 21.0 | 8 |
| 3 | 253.3 | 139.7 | 207.4 | 45.9 | 68 |
| 4 | 150.9 | 15.5 | 63.4 | 87.5 | 216 |
| 5 | 201.2 | 12.8 | 52.4 | 148.8 | 379 |
| 6 | 253.3 | 13.7 | 57.4 | 195.9 | 501 |

*Normalised back to neat liquor conditions with malonate correction to account for volume changes

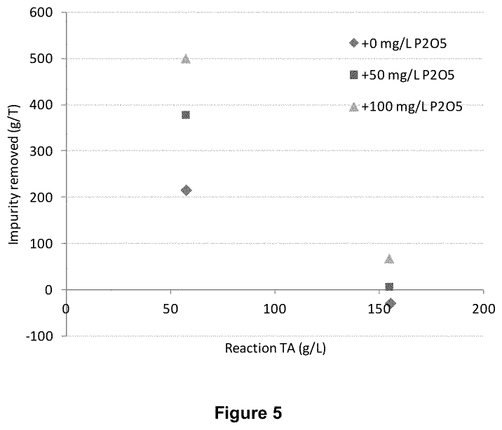

FIG. 5 shows the uptake at the two different liquor strengths for the three P₂O₅ concentrations. Impurity uptake was significantly higher at the lower TA than the undiluted liquor TA. At a given TA, P₂O₅ uptake increased with P₂O₅ addition, but for the higher TA solutions, the additional 50 or 100 mgL⁻¹ P₂O₅ added did not result in an additional 50 or 100 mgL⁻¹ removal. For the three dilute solutions, the remaining P₂O₅ in the product liquor dropped to a level of 12-15 mgL⁻¹ at the three P₂O₅ concentrations, suggesting that at these concentrations, P₂O₅ is almost totally removed despite the initial concentration.

1. A method for controlling the concentration of impurities in Bayer liquors, the method comprising the steps of:
adding an oxide and/or a hydroxide of a metal other than aluminium to a Bayer liquor with a desired TA;
forming a layered double hydroxide; and
incorporating at least one impurity in the layered double hydroxide,
wherein the impurities comprise at least one of phosphorus, vanadium and silicon impurities, and
wherein the incorporation of the at least one impurity decreases with increasing TA.

2. The method of claim 1, wherein the desired TA is less than 160 gL⁻¹.

3. The method of claim 1, comprising: monitoring a concentration of at least one impurity in a Bayer circuit.

4. The method of claim 1, comprising: measuring the concentration of at least one impurity in the Bayer liquor with a desired TA.

5. The method of claim 1, comprising:
measuring the concentration of at least one impurity in a Bayer liquor with a desired TA;
prior to the step of:
adding the oxide and/or the hydroxide of a metal other than aluminium to the Bayer liquor with a desired TA.

6. The method of claim 1, comprising:
measuring the concentration of at least one impurity in a Bayer liquor with a desired TA;
after the step of:
incorporating the at least one impurity in the layered double hydroxide.

7. The method of claim 1, wherein the concentration of the at least one impurity in the Bayer liquor after the formation of the layered double hydroxide is less than the concentration of the at least one impurity prior to the step of adding the oxide and/or the hydroxide of a metal other than aluminium to the Bayer liquor.

8. The method of claim 1, comprising:
obtaining a Bayer liquor with a desired TA.

9. The method of claim 1, comprising:
treating the Bayer liquor to achieve the desired TA.

10. The method of claim 9, wherein the Bayer liquor is treated to reduce the TA.

11. The method of claim 1, wherein the step of incorporating the at least one impurity in the layered double hydroxide results in a reduction of the concentration of the at least one impurity by at least 10%.

12. The method of claim 1, comprising:
adding the at least one impurity to the Bayer liquor to provide an enriched Bayer liquor;
prior to the step of:
forming the layered double hydroxide

13. The method of claim 1, wherein the Bayer liquor is washer overflow, diluted spent liquor, diluted green liquor or lakewater.

14. The method of claim 1, wherein the metal other than aluminium is selected from the group comprising calcium and magnesium.

15. The method of claim 1, wherein the layered double hydroxide is hydrocalumite and/or hydrotalcite.

16. The method of claim 1, wherein the Bayer liquor has a TA less than 100 gL⁻¹.

17. The method of claim 1, wherein the Bayer liquor has a TA less than 75 gL⁻¹.

18. The method of claim 1, wherein the Bayer liquor has a TA between 50 and 100 gL⁻¹.

19. The method of claim 1, wherein the impurities are selected from the group consisting of phosphorus, vanadium, silicon, and combinations thereof.
